(19) United States
(12) Patent Application Publication
(10) Pub. No.: US 2005/0284480 A1
(43) Pub. Date: Dec. 29, 2005

(54) Passenger oxygen mask

(76) Inventors: Wolfgang Rittner, Siblin (DE); Rudiger Meckes, Berkenthin (DE)

Correspondence Address: MCGLEW & TUTTLE, PC, P.O. BOX 9227, SCARBOROUGH STATION, SCARBOROUGH, NY, 10510-9227, US

(21) Appl. No.: 11/159,030

(22) Filed: Jun. 22, 2005

(30) Foreign Application Priority Data
Jun. 23, 2004 (DE) 10 2004 030 336.3

(51) Int. Cl. A62B 18/02

(52) U.S. Cl. 128/205.25; 128/206.21

(57) ABSTRACT

A passenger oxygen mask for an aircraft with a mask body which is to come to bear on the face in a use situation and which engages over of the mouth and nose in the correct position of use. A lead-through for a drinking tube is provided.

### CROSS REFERENCE TO RELATED APPLICATIONS

This application claims the benefit of priority under 35 U.S.C. § 119 of DE 10 2004 030 336.3 filed Jun. 23, 2004, the entire contents of which are incorporated herein by reference.

### FIELD OF THE INVENTION

The invention relates to a passenger oxygen mask for an aircraft with a mask body which is to come to bear on the face of a passenger in use and which engages over the mouth and nose in the correct position.

### BACKGROUND OF THE INVENTION

After the occurrence of decompression on board a passenger aircraft, it is usual for reasons of safety to reduce the altitude of the aircraft to a height which permits breathing without an additional oxygen supply. The distance to the destined airport or to a diversion airport may be quite considerable depending on the flight path and the location of the occurrence of the decompression, so that the low flight altitude leads to a significantly higher consumption of fuel which for this reason must be carried along on board as a precaution, which implies a corresponding large weight load, and thus a limitation of the loading capacity of the aircraft which this entails.

For this reason, in the case of decompression, one strives to lower the altitude to a height which is acceptable with regard to the additional fuel consumption, and to supply the passengers with additional oxygen via passenger oxygen masks for the remaining flight duration.

This oxygen is hardly laden with water, which in particular with an extended use of the passenger oxygen mask accelerates the dehydration of the body. If the fluid loss is not compensated by the intake of fluid, the blood pressure and thus the speed of the blood circulation which this entails are reduced, by which means the risk of a clotting of the blood leading to thrombosis is increased. For this reason the passengers should drink at least one glass of fluid per hour of flight.

This is very difficult if not impossible with the use of known passenger oxygen masks, since the masks must be removed for drinking.

### SUMMARY OF THE INVENTION

Against this background, it is the object of the present invention to provide a passenger oxygen mask which ensures an adequate supply of oxygen to the passenger and at the same time permits a simple intake of fluid.

The passenger oxygen mask according to the invention for an aircraft comprises a mask body envisaged to take its bearing (contacts) on the face and to engage over the mouth and nose in its correct position. A lead-through for a drinking tube is provided on the passenger oxygen mask, with which fluid may be taken from a beaker or a bottle without having to remove the mask.

The mask body of the passenger oxygen mask in the known manner is designed in the shape of a truncated cone and consists of an elastic plastic. The larger of the two end-faces of the mask body is open and forms a breathing opening of the oxygen mask which the passenger applies onto his face covering the mouth and nose. The second end-face of the mask body which is distanced to the breathing open is designed in a closed manner. Usually the oxygen supply to the mask body is connected to this closed end-face.

It is preferably in the region of this closed end-face that a lead-through is provided, through which a drinking tube may be introduced into the inside of the mask body, so that the passenger when the passenger oxygen mask is applied may consume drinks via the drinking tube which is led through the lead-through into the inside of the mask.

Alternatively, the lead-through for the drinking tube may also be arranged at any other location of the passenger oxygen mask, however the position of the lead- through should ensure that the passenger may introduce the drinking tube into his mouth, and a comfortable consumption of fluid through the drinking tube is possible. Thus for example an embodiment with which the lead-through for the drinking tube is arranged on the peripheral surface of the mask body, for example near to the end-face containing the oxygen connection, is also conceivable.

An opening advantageously forms the lead-through. The dimensions and the cross-sectional shape of this opening are usefully adapted to the outer dimensions and the cross-sectional contour of the drinking tube. In this manner when the opening has been penetrated, the intermediate space between the drinking tube and the opening edge of the lead-through may be designed as small as possible and thus the penetration of external air into the mask body is prevented.

Preferably the opening is designed in a round manner and has a diameter which corresponds essentially to the diameter of usual drinking straws, so that these may be applied as the drinking tube for the passenger oxygen mask.

In order to simplify the introduction of the drinking tube into the opening by the passenger when the mask has been applied, it is advantageous on the edge of the opening at the outer side to arrange a slight prominence, e.g. in the form of a bead-like material thickening surrounding the opening edge. This prominence permits the touch sensing of the opening and thus the leading of a drinking tube through this opening. If the opening is envisaged for leading through a drinking tube at the flexible peripheral surface of the mask body, then the prominence of the opening edge may furthermore accompany a material stiffening which additionally simplifies the leading-through of the drinking tube.

The opening is usefully designed to close in a self-acting manner (automatically). In order to prevent the penetration of external air into the mask body, it is necessary for the opening for leading through the drinking tube to be closed in an airtight manner after removing the drinking tube. For this reason a closure of the opening is arranged on the opening, preferably on its inner side which faces the face of the user of the passenger oxygen mask. This is designed to close automatically so that the use of the passenger oxygen mask is not made unnecessary complicated in that the passenger is required to open the opening closure before the intake of fluid and close it again after drinking.

It is advantageous to provide one or more flaps closing the opening, preferably at the inside. Thus a spring-biased flap may be arranged on the inner edge of the opening, which on introduction of the drinking tube is displaced by the drinking tube and folds open into the inside of the mask body and thus releases the opening, but which on withdrawal of the drinking tube however again flaps closed on account of the spring bias, and closes the opening. The spring bias may be realized by way of the selection of suitable materials as well as by way of the application of suitable spring elements.

Furthermore the possibility exists of arranging a closure flap on the inner side of the opening, said closure flap being connected on the complete periphery of the edge of the opening. In order to be able to lead a drinking tube through the opening, the surface of the closure flap which covers the opening is slotted in a radial manner such that closure flap segments are formed which, proceeding from the edge of the opening, converge in a pointed manner to the middle point of the opening. If the opening segments or at least sections of these opening segments are designed in a flexible manner in the region of the connection to the opening, then on penetration of the drinking tube into the opening they may be displaced laterally by this drinking tube and subsequently bear against the outer wall of the drinking tube in a sealing manner.

After the drinking tube has been removed from the opening and the passenger oxygen mask continues to be used only for supporting the breathing, the closure cap closes the opening in an airtight manner. For this it is useful for the opening closure to be designed such that its closure force is significantly higher than the opening force which acts on this opening closure on account of the breathing activity. In this manner one prevents the opening closure from being lifted from the opening an account of the vacuum produced by way of the breathing to the extent that external air may penetrate through the opening in the mask body.

All further closure elements such as those which are applied with air mattresses and rubber dinghies may also be applied for the self-acting closure of the opening, which on the one hand ensure a penetration by way of a drinking tube effected from the outside and on the other hand ensure a secure closure of the opening after removal of the drinking tube.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

The invention is hereinafter described in more detail by way of one embodiment example represented in the drawings. In the drawings:

FIG. 1 is a perspective sketch of a passenger oxygen mask according to the invention; and

FIG. 2 is a perspective sketch of the passenger oxygen mask shown in FIG. 1, with a drinking tube led through the opening.

### DESCRIPTION OF THE PREFERRED EMBODIMENT

Referring to the drawings in particular, the represented passenger oxygen mask 2 comprises a truncated-cone-shaped mask body 4 which is formed of a flexible plastic. The mask body 4 has a larger end-face designed in an open manner and forms the breathing opening 6 which the passenger applies to his face in the case of resuscitation. A closed end-face 8 of the mask body is arranged at the end of the mask body 4 which is distanced to the breathing opening 6.

This end-face 8 comprises a central opening which is provided for the closure 10 for the oxygen supply. The oxygen supply is indicated in the figures by way of a supply bag 12 fastened to the connection 10 as well as an oxygen flexible tubing 14 connected to the supply bag 12.

An opening 16 is arranged at the end-face 8 next to the connection 10 for the oxygen supply. This opening 16 serves for receiving a drinking tube 18 as is represented in FIG. 2. The outer edge 20 around the opening 16 is formed in a bead-like manner and projects beyond the end-face 8. This permits the passenger, when the passenger oxygen mask 2 has been placed on, to sense the opening 16 by touch without viewing contact, in order to push the drinking tube 18 through the opening 16 into the inside of the mask body 4. Furthermore the opening 16 is stiffened by way of the bead-like design of the outer edge 20.

With the prominence of the outer edge 20 it may be the case of a material thickening of the end-face 8 as well as of a separate mount to which a closure flap 22 for the closure of the opening 16 is connected.

This closure flap 22 is arranged on the inside of the end-face 8, i.e. on that side of the end-face 8 facing the face (of the user), and closes the opening 16 in an airtight manner when a drinking tube 18 has not been led through, so that no external air may penetrate into the inside of the passenger oxygen mask 2 through the opening 16.

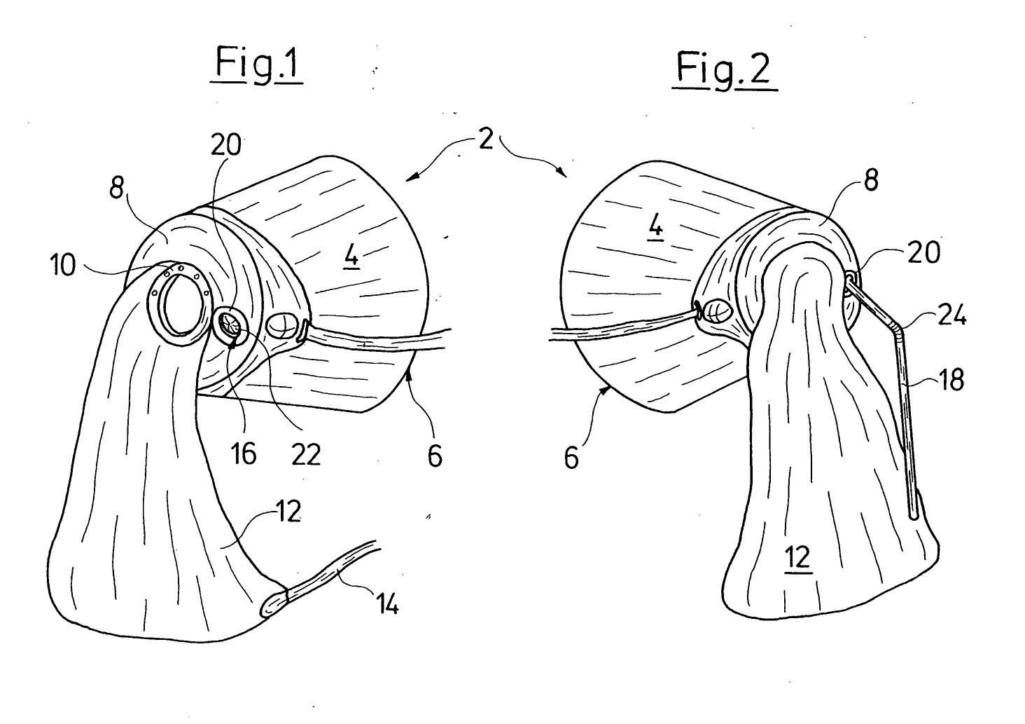

The closure flap 22 represented in FIG. 1 is connected on over the complete periphery of the opening 16. The surface of the closure cap 22 which covers the opening 16 is slotted in a splayed manner, wherein the radially running slits meet in the center of the opening 16. The closure segments of the closure cap 22 which arise on account of the slits are formed at least partly in a flexible manner, preferably in the region of the connection to the opening 16, so that displaced by the drinking tube 18, they flap apart on leading through a drinking tube 18 and thus release the path for the drinking tube 18 and simultaneously seal the mask body with respect to the drinking tube 18. At the same time the closure force of the segments of the closure cap 22 forces this closure flap 22 against the outer wall of the drinking tube 18 so that the intermediate space between the drinking tube 18 and the opening 16 are closed by the segments. In the same manner the segments of the closure flap 22 close the opening 16 after removal of the drinking tube 18.

FIG. 2 shows the passenger oxygen mask 2 with a drinking tube 18 which is led through the opening 16. This drinking tube 18 has a region 24 which is designed such that the drinking tube 18 may be bent in order to be able to introduce the end distanced to the mask body better into a drinking vessel (not shown) without buckling the drinking tube 18.

While specific embodiments of the invention have been shown and described in detail to illustrate the application of the principles of the invention, it will be understood that the invention may be embodied otherwise without departing from such principles.

1. A passenger oxygen mask for an aircraft, the passenger oxygen mask comprising:
a mask body which is to bear on the face of a passenger user so as to engage over the mouth and nose in a correct position of use; and
a lead-through for a drinking tube, the lead-through being formed on said mask body.

2. A passenger oxygen mask according to claim 1, wherein said lead-through includes an opening formed in said mask body.

3. A passenger oxygen mask according to claim 2, wherein the opening is designed to close in a self-acting manner.

4. A passenger oxygen mask according to claim 2, wherein said lead-through further comprises flaps which close the opening.

5. A passenger oxygen mask according to claim 4, wherein said flaps are extended to close the opening at the inside of said mask body.

6. A passenger oxygen mask according to claim 2, wherein said lead-through further comprises an opening closure to close the opening in a self-acting manner, said opening closure having a closure force that is significantly higher that the opening force associated with on account of the breathing activity, which acts on said opening closure.

7. A passenger oxygen mask according to claim 6, wherein said opening closure comprises flaps which close the opening.

8. A passenger oxygen mask according to claim 7, wherein said flaps extend to close the opening at the inside of said mask body.

9. An aircraft passenger oxygen mask system comprising:
a mask body which is to bear on the face of a passenger user so as to engage over the mouth and nose in a correct position of use; and
a lead-through for a drinking tube, the lead-through including an opening formed in said mask body; and
a drinking tube which is positionable to lead through the opening.

10. A passenger oxygen mask system according to claim 9, wherein the opening is designed to close in a self-acting manner.

11. A passenger oxygen mask system according to claim 9, wherein said lead-through further comprises flaps which close the opening.

12. A passenger oxygen mask system according to claim 11, wherein said flaps extend to close the opening at the inside of said mask body.

13. A passenger oxygen mask system according to claim 9, wherein said lead-through further comprises an opening closure to close the opening in a self-acting manner, said opening closure having a closure force that is significantly higher that the opening force associated with on account of the breathing activity, which acts on said opening closure.

14. A passenger oxygen mask system according to claim 13, wherein said opening closure comprises flaps which close the opening.

15. A passenger oxygen mask system according to claim 14, wherein said flaps extend to close the opening at the inside of said mask body.
